(19) United States
(12) Patent Application Publication
(10) Pub. No.: US 2024/0360781 A1
(43) Pub. Date: Oct. 31, 2024

(54) COMBINED GASKET AND SEAL

(71) Applicant: Caterpillar Inc., Peoria, IL (US)

(72) Inventors: Adam Paul Berry, Peoria, IL (US); Wesley A. Thill, Peoria, IL (US)

(73) Assignee: Caterpillar Inc., Peoria, IL (US)

(21) Appl. No.: 18/140,817

(22) Filed: Apr. 28, 2023

(51) Int. Cl. F01N 13/18; F16J 15/12

(52) U.S. Cl. CPC F01N 13/1827; F16J 15/128

(57) ABSTRACT

A gasket assembly includes an upper metal layer and a lower metal layer. A seal is coupled between the upper metal layer and the lower metal layer. The seal can be comprised of a non-metal material. The gasket assembly can be provided at a joint in an exhaust system.

### TECHNICAL FIELD

The present application relates generally to internal combustion engines. More particularly, the present application relates to sealing apparatuses in exhaust assemblies of gas engines.

### BACKGROUND

Gaskets can provide a seal between mating mechanical components. For example, gaskets can provide sealing for exhaust assemblies in automotive and construction equipment applications. In these and similar use cases, the exhaust gasket seals combustion gases into the exhaust system. However, in some vehicle designs, coolant ports are provided relatively near exhaust ports. This can present challenges in gasket design because of the variations in temperature and the difficulty in sealing fluids or gases of widely varying temperature.

U.S. Pat. No. 5,924,701A describes a dual purpose, multi-layered steel intake/exhaust manifold gasket constructed from a rubber coated embossed single-layer intake manifold gasket attached to an uncoated embossed double-layer exhaust manifold gasket. The gaskets overlap at discontinuous locations along a common edge by sandwiching the single layer intake manifold gasket between the two layers of the exhaust manifold gasket.

### SUMMARY OF THE INVENTION

In one example, a gasket assembly comprises an upper metal layer and a lower metal layer. The gasket assembly also includes a seal coupled between the upper metal layer and the lower metal layer; the seal being comprised of a non-metal material.

In another example, a system includes a first component mated at a joint with a second component. The system includes a gasket assembly disposed at the joint. The gasket assembly includes an upper metal layer and a lower metal layer. The gasket assembly further includes seal coupled between the upper metal layer and the lower metal layer. The seal can be comprised of a non-metal material joined to a metal carrier.

In another example, a method of sealing an exhaust system can include mating a first system component to a second system component, thereby creating an exhaust system joint. The method can include providing a gasket assembly at the exhaust system joint. The gasket assembly can include an upper metal layer and a lower metal layer. The gasket assembly can include a seal coupled between the upper metal layer and the lower metal layer, the seal being comprised of a non-metal material joined to a metal carrier.

### BRIEF DESCRIPTION OF THE DRAWINGS

FIG. 1 is a perspective view of an example gas engine.

FIG. 2A is a view of a portion of an exhaust manifold and cylinder head including a gasket assembly according to various embodiments.

FIG. 2B illustrates a gap at a joint between an exhaust manifold and cylinder head wherein a gasket assembly may be provided according to various embodiments.

FIG. 3A is a front view of a gasket assembly according to various embodiments.

FIG. 3B is a side view of a gasket assembly according to various embodiments.

FIG. 3C illustrates a gasket assembly mounted on a portion of an exhaust assembly according to various embodiments.

FIG. 4 illustrates a method of sealing an exhaust system according to various embodiments.

### DETAILED DESCRIPTION

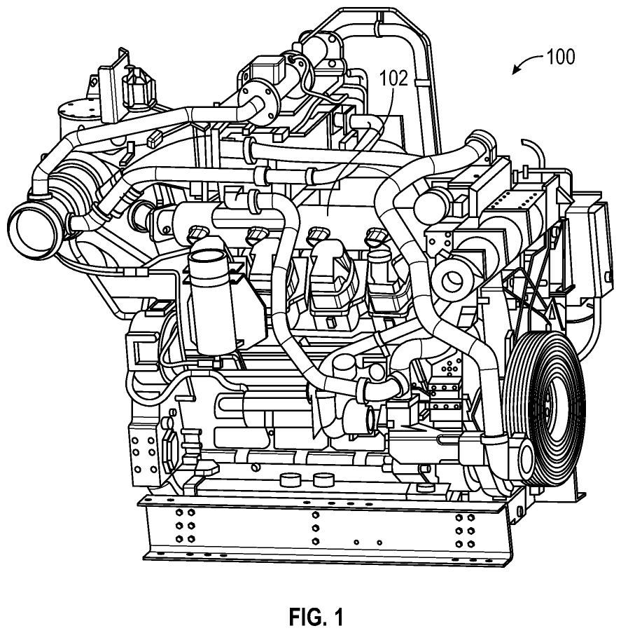

FIG. 1 is a perspective view of an example internal combustion engine 100 that includes an exhaust manifold assembly 102. While a gas engine is described, embodiments are not limited to gas engines, and embodiments can be implemented on, for example, diesel engines. The internal combustion engine 100 may be any engine configured to generate power using a gaseous fuel, for example, such as an internal combustion engine. Gaseous fuels are fuels that are in a gaseous state under ordinary conditions such as at standard temperature and pressure. The exhaust manifold assembly 102 may include a water-cooled exhaust manifold to lower surface temperatures of the internal combustion engine 100, for example.

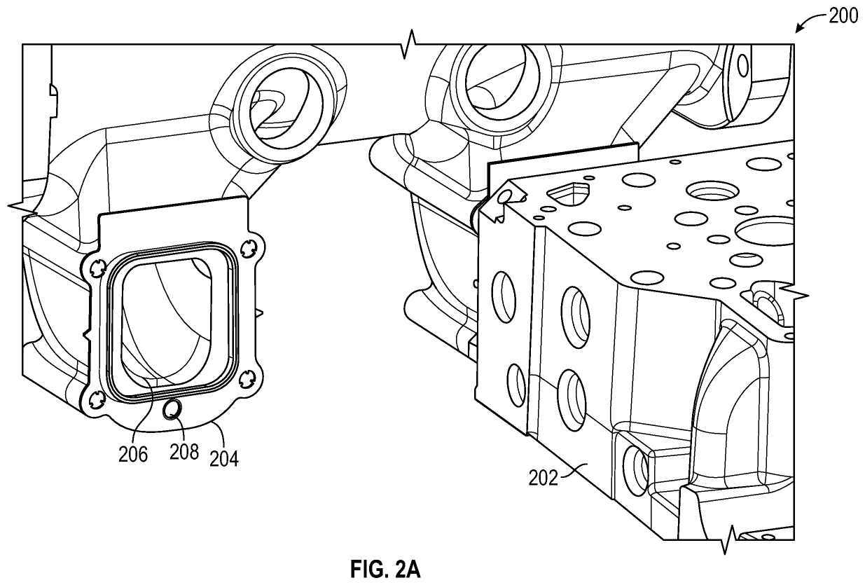

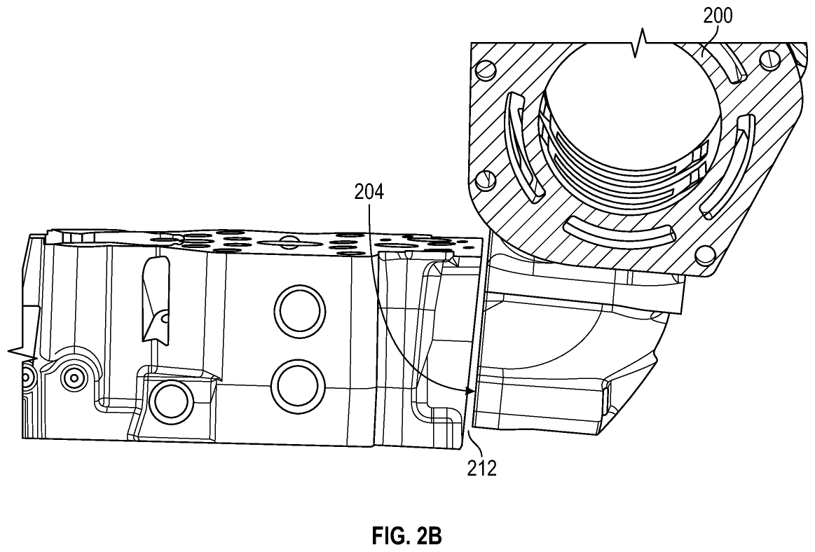

FIG. 2A is a view of a portion of an exhaust manifold 200 (e.g., a first component of a system, e.g., exhaust system) and cylinder head 202 according to various embodiments. Exhaust manifold 200 may be included within the exhaust manifold assembly 102, with only a portion of the exhaust manifold assembly 102 shown in FIG. 2A for purposes of clarity and to provide a view of a cylinder head 202 where a gasket assembly according to embodiments can be mounted. While one cylinder head 202 is shown for clarity, it will be appreciated that the internal combustion engine 100 can include any number of cylinder heads for each engine cylinder, for example four cylinders, six cylinders, 16 cylinders, or more.

The exhaust manifold 200 includes an exhaust inlet 206 and a coolant port 208. The coolant port 208 can provide an outlet for a coolant passage not shown in FIG. 2A that is configured to receive a coolant through one or more coolant inlets. The coolant may be water, or any other liquid or gaseous substance selected to provide cooling for components of the engine.

The cylinder head 202 can be sealed at a joint 212 using a thin gasket seal 204 to the exhaust manifold 200 as seen in FIG. 2B. A seal can be provided at this joint for sealing exhaust and coolant within the system. Seal design can become critical in some engine and exhaust manifold 200 designs because of the proximity of the exhaust inlet 206 with coolant port/s 208. This proximity is significant because materials of the seal must be able to withstand the variations in temperature between relatively hot or warm exhaust and relatively cool or cold coolants. In some example systems, the exhaust inlet 206 can be within less than 20 millimeters from the coolant port 208, and in some embodiments the proximity can be on the order of 10-12 millimeters.

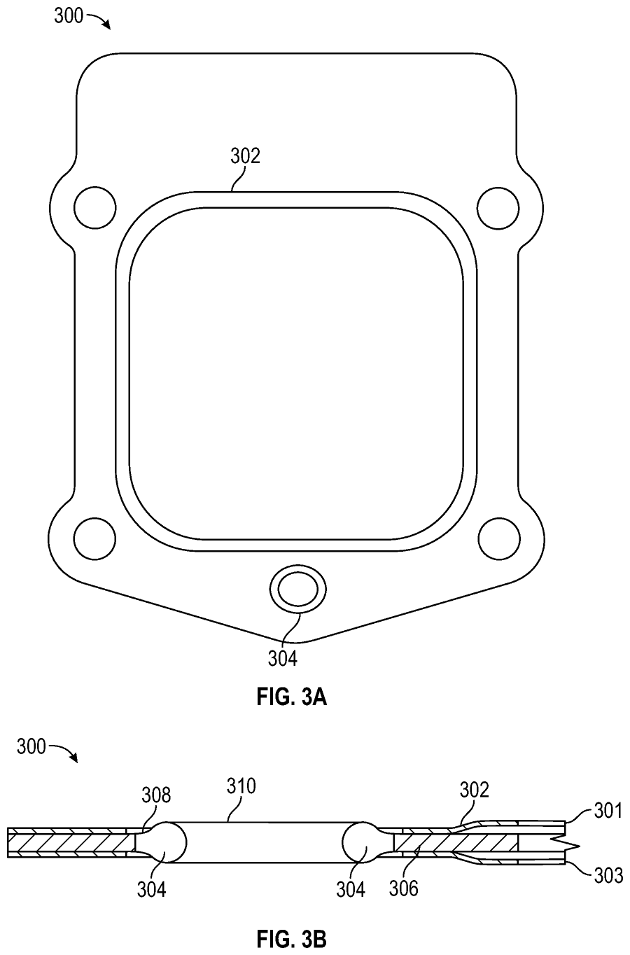

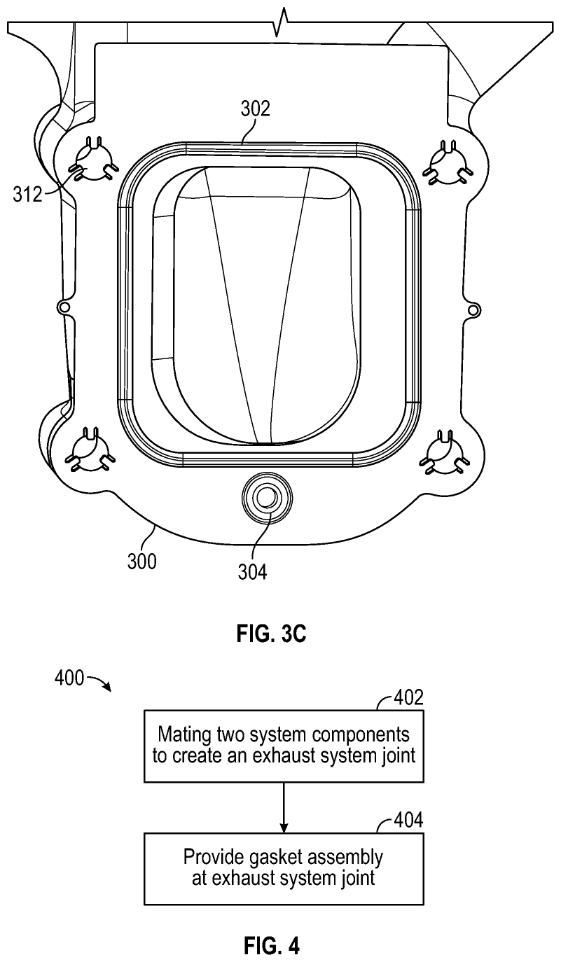

Gasket assemblies according to embodiments address these and other concerns by providing a combined gasket and seal assembly that can be provided to seal the above-described joint. FIG. 3A is a front view of a gasket assembly 300 according to various embodiments. FIG. 3B is a side view of the gasket assembly 300 according to various embodiments. The different views depicted in FIG. 3A and FIG. 3B can be referred to simultaneously as needed for description of the gasket assembly 300 according to embodiments.

The gasket assembly 300 can include a gasket portion 302 for sealing exhaust portions of a system, and a seal portion 304 for sealing coolant portions.

A relatively thick (e.g., on the order of about 1-3 millimeters) gasket assembly 300 should be provided to accommodate tolerance stack up (TSU) between exhaust manifold 200 sections w % ben sealing exhaust and coolant in a single joint 212 between cylinder head 202 and exhaust manifold 200. Furthermore, to mitigate relaxation in the joint, the gasket 302 portion should not be made of a soft material (e.g., rubber or graphite) and, instead, gasket 302 should be comprised of hard materials. Further, the carrier material 306 (further described later herein) should be comprised of a hard (not soft material).

The gasket 302 portion can be made up of a multi-layer steel (MLS) gasket (e.g., stainless steel) although embodiments are not limited to steel and can include any metal or other type of steel, nickel, etc. The gasket 302 portion can include an upper metal layer 301 and a lower metal layer 303. While two layers are depicted, this is for purposes of clarity only, and the MLS gasket can include several thinner layers or layers of variable thickness.

The gasket assembly can include a seal portion 304 bonded to the layer 306 between the upper metal layer 301 and the lower metal layer 303. The seal portion 304 can comprise a non-metal material such as rubber. The seal 304 is molded (e.g., edge molded although embodiments are not limited thereto) to the center (carrier) layer 306. In embodiments of more than three layers, the carrier layer 306 may be comprised of multiple layers or can be any one or more layers among a number of central or center layers.

The gasket assembly 300 can include a carrier material 306 between the upper metal layer 301 and the lower metal layer 303. The carrier material 306 should be comprised of a hard material such as, e.g., steel, or stainless steel. The seal 304 can be coupled (e.g., molded, edge molded or over molded) to the carrier material 300 or other metal layer. In examples, the upper metal layer 301 and the lower metal layer 303 can be embossed. The embossing can be adapted to be positioned so that the upper metal layer 301 and the lower metal layer 303 can be compressed into sealing engagement with the carrier material 306 (e.g., a compaction force, a bolt force or a spring force can be applied). In some examples, bolt force can flatten the embossment, and the embossment is configured to spring back to the embossment original shape or similar to the original shape, providing the sealing force.

As seen in FIG. 3B, the seal 304 can be edge bonded to the center layer 306 at the points shown 308.

FIG. 3C illustrates a gasket assembly 300 mounted on a portion of an exhaust manifold 200 according to various embodiments. As can be seen in the figure, the gasket assembly 300 can include apertures 312 configured to receive a fastening system. The fastening system can include bolts, rivets, welded joints, etc. The overall gasket assembly 300 can vary in length and width dimensions depending on the type of work machine or internal combustion engine 100. In examples, the gasket assembly 300 can be on the order of less than 200 millimeters wide and less than 200 millimeters long. In some examples, the gasket assembly 300 can be about 125-135 millimeters wide and about 140-160 millimeters long although embodiments are not limited thereto. The gasket assembly 300 can be provided at multiple joints in the internal combustion engine 100 or similar assembly, for example between each cylinder head and exhaust manifold portion.

FIG. 4 illustrates a method 400 of sealing an exhaust system according to various embodiments. The method can begin operation 402 with mating a first system component to a second system component (e.g., exhaust manifold 200 and cylinder head 202), thereby creating an exhaust system joint 212.

The method 400 can continue with operation 404 with providing a gasket assembly 300 at the exhaust system joint 212. As described earlier herein, the gasket assembly 300 can include an upper metal layer 301 and a lower metal layer 303. The gasket assembly 300 can include a seal 304 coupled between the upper metal layer 301 and the lower metal layer 303. As described earlier herein, the seal 304 can be comprised of a non-metal material such as rubber.

By providing the gasket assembly 300 as in method 400 and according to the description provided earlier herein, sealing of both exhaust and coolant ports of different temperatures can be achieved. An MLS gasket assembly can include a molded rubber seal (e.g., seal 304, which can be edge molded although embodiments are not limited thereto) between at least two layers of metal (e.g., steel) embossed layers providing compatible sealing for lower temperature applications or fluids such as coolant.

### INDUSTRIAL APPLICABILITY

In one illustrative example, an internal combustion engine 100 can include an exhaust system that includes a joint where two portions of the engine are mated. An assembly is provided at that joint that seals both a high temperature gas/fluid and a low temperature gas/fluid. The high temperature gas/fluid may include exhaust and the low temperature gas/fluid can comprise coolant. A gasket portion of the assembly can be comprised of a metal for sealing an exhaust portion of the system and a seal portion of the assembly can include rubber or other non-metal for sealing coolant or other relatively cool fluids within the system.

The above detailed description is intended to be illustrative, and not restrictive. The scope of the disclosure should, therefore, be determined with references to the appended claims, along with the full scope of equivalents to which such claims are entitled.

1. A gasket assembly comprising:
an upper metal layer and a lower metal layer;
a carrier material, comprised of a metal, between the upper metal layer and the lower metal laver; and
a seal coupled between the upper metal layer and the lower metal layer, the seal being comprised of a non-metal material, wherein the seal is attached to an inner edge surface of the carrier material.

2. The gasket assembly of claim 1, wherein the seal defines a continuous, integral structure throughout a height of the seal both above and below the carrier material.

3. The gasket assembly of claim 2, wherein the seal is edge-molded to the inner edge surface of the carrier material around a coolant port of the carrier material.

4. The gasket assembly of claim 2, wherein at least one metal layer is embossed.

5. The gasket assembly of claim 4, wherein the upper metal layer and the lower metal layer are configured to apply a compaction force to the carrier material.

6. The gasket assembly of claim 1, wherein the upper metal layer and the lower metal layer comprise steel.

7. The gasket assembly of claim 6, wherein the upper metal layer and the lower metal layer comprise stainless steel.

8. The gasket assembly of claim 1 wherein the seal comprises rubber.

9. The gasket assembly of claim 1, further including apertures configured to receive a fastening system.

10. A system comprising:
a first component mated at a joint with a second component; and
a gasket assembly disposed at the joint, the gasket assembly comprising:
an upper metal layer and a lower metal layer;
a metal carrier positioned between the upper metal layer and the lower metal layer; and
a seal coupled between the upper metal layer and the lower metal layer, the seal being comprised of a non-metal material joined to an inner edge surface of the metal carrier.

11. The system of claim 10, wherein the first component comprises an exhaust manifold.

12. The system of claim 11, further comprising an exhaust port and a coolant port, and wherein the seal is configured to seal the coolant port.

13. The system of claim 12, wherein the seal defines a continuous, integral structure throughout a height of the seal both above and below the metal carrier.

14. The system of claim 13, wherein at least one of the upper metal layer and the lower metal layer is embossed and wherein the upper metal layer and the lower metal layer are configured to apply a compaction force to the carrier material to seal the exhaust port.

15. The system of claim 14, wherein the compaction force is applied to at least one of the first component and the second component to seal the exhaust port.

16. The system of claim 10, wherein the upper metal layer and the lower metal layer comprise steel.

17. A method of sealing an exhaust system, comprising:
mating a first system component to a second system component, thereby creating an exhaust system joint; and
providing a gasket assembly at the exhaust system joint, the gasket assembly comprising:
an upper metal layer and a lower metal layer;
a metal carrier positioned between the upper metal layer and the lower metal layer; and
a seal coupled between the upper metal layer and the lower metal layer, the seal being comprised of a non-metal material joined to an inner edge surface of the metal carrier.

18. The method of claim 17, wherein the seal defines a continuous, integral structure throughout a height of the seal both above and below the metal carrier.

19. The method of claim 18, wherein the exhaust system include an exhaust port and a coolant port, and wherein the method comprises providing the seal to seal the coolant port.

20. The method of claim 19, further comprising applying a compaction force to the upper metal layer and the lower metal layer to seal the exhaust port.
